(19) United States
(12) Patent Application Publication
(10) Pub. No.: US 2022/0283449 A1
(43) Pub. Date: Sep. 8, 2022

(54) CONTACT LENS

(71) Applicant: YUNG SHENG OPTICAL CO., LTD., TAICHUNG CITY (TW)

(72) Inventors: TSUNG-MIN TSAI, TAICHUNG CITY (TW); CHIEH-KAI WANG, TAICHUNG CITY (TW); CHIEN-HSIU CHEN, TAICHUNG CITY (TW)

(21) Appl. No.: 17/685,162

(22) Filed: Mar. 2, 2022

(30) Foreign Application Priority Data
Mar. 3, 2021 (TW) 110107542

(51) Int. Cl. G02C 7/04

(52) U.S. Cl. CPC G02C 7/044

(57) ABSTRACT

Disclosed is a contact lens comprising an optical region including a first area, a second area and a third area, concentrically arranged in such order from a lens center. The first area includes a correction zone having a nearsightedness correcting power. The second and third areas each include at least two defocusing zones and at least one correction zone, wherein the at least two defocusing zones and the at least one correction zone are alternatively arranged. The second area has a first power difference of −2.00 to −5.00 D, the third area has a second power difference of −3.00 to −10.00 D, and the second power difference is equal to or more negative than the first power difference.

### CROSS REFERENCE TO RELATED APPLICATIONS

This application claims priority under 35 U.S.C. § 119(a) to Taiwan Patent Application No. 110107542 filed Mar. 3, 2021, the content of which is incorporated herein by reference in its entirety.

### TECHNICAL FIELD

The present invention relates to a contact lens, and particularly to a contact lens which is able to slow the progression of myopia and is comfortable to wear, and a mold for manufacturing said contact lens.

### BACKGROUND

Please refer to FIG. 1, a schematic diagram of correcting myopia by using a conventional contact lens. The principle of conventional myopia correction is to assist focusing an image on a retinal imaging area C of an eyeball A through a contact lens 1 with a single focus, wherein the contact lens 1 includes a lens light focusing region E1 and a lens optical region E2 concentrically arranged in such order from a lens center, the lens light focusing region E1 being a part of the lens optical region (effective visual region) E2, a diameter D1 of the lens light focusing region E1 being smaller than a diameter D2 of the lens optical region E2, and the diameter D2 of the lens optical region E2 being smaller than a diameter D of the contact lens 1. Parameters of contact lens 1 are designed based on the goal of myopia correction by the power of the contact lens 1 to focus an image to a central focus C1 through the pupil B.

However, it is generally believed in the art that the above-described design would lead to new problems. That is, lens design such as one of contact lens 1 would cause the myopia of schoolchildren to worsen continuously.

The eye axes of schoolchildren are naturally short and most of them are farsighted, but the eye axes will grow with age and gradually develop towards normal vision. Because the design of the contact lens 1 does not consider the curvature of retina, in myopia correction the contact lens 1 often causes the peripheral focus to fall behind the retina (see the upper peripheral focus C2 and the lower peripheral focus C3 in FIG. 1), which leads to an overcorrection. In addition to normal axial length growth of schoolchildren, the eyeball A would further grow to increase the axial length in order to allow the upper peripheral focus C2 and the lower peripheral focus C3 to fall on the retina, resulting in continuous myopia worsening.

To solve the above technical problems, U.S. Pat. No. 7,637,612B2 and WO2013015743A1 disclose contact lenses with correcting powers decreasing from a lens center to an outer zone of the lens. Although this design principle can achieve the effect of slowing the progression of myopia, but in actual wearing where a wearer is looking at distant objects, the farther the objects are, the more blurred the objects will be. Furthermore, a significant parallax would form between the center and the periphery of the lens, making the wearer uncomfortable.

In addition, U.S. Pat. No. 9,829,722B2 and WO2012034265A1 propose alternate defocusing zones and correction zones disposed on the lens periphery so that the peripheral focuses do not fall behind the retina. In such prior art, the correcting power difference between the defocusing zones and the correction zones is set to be −0.50 to −10.00 D; however, there is configured only one area with power difference, and the power difference is identical. As such, when difference between the correction power of the correction area and the correction power of the defocusing area is large, the phenomenon of parallax still occurs; and when difference between the correction power of the correction area and the correction power of the defocusing area is small, the defocusing effect is little (unable to slow the progression of myopia).

### SUMMARY OF THE INVENTION

In view of the technical problems of the prior art, the present invention provides a contact lens. The contact lens comprises an optical region including a first area (OZ1), a second area (OZ2) and a third area (OZ3), concentrically arranged in such order from a lens center. The first area includes a correction zone having a nearsightedness correcting power. The second and third areas each include at least two defocusing zones and at least one correction zone, wherein the at least two defocusing zones and the at least one correction zone are alternatively arranged. The second area has a first power difference of −2.00 to −5.00 D (G1 as shown in FIGS. 4-9), the third area has a second power difference of −3.00 to −10.00 D (G2 as shown in FIGS. 4-9), and the second power difference is equal to or more negative than the first power difference.

According to certain embodiments of the present invention, the first area extends outwardly from the lens center to an outer periphery of the first area, the outer periphery of the first area having a radial distance to the lens center of L1, the second area extends outwardly from the outer periphery of the first area to an outer periphery of the second area, the outer periphery of the second area having a radial distance to the lens center of L2, and the third area extends outwardly from the outer periphery of the second area to an outer periphery of the third area, the outer periphery of the third area having a radial distance to the lens center of L3, wherein L1 is 2±0.5 mm, L2 is 3±0.5 mm, and L3 is 4.5±0.5 mm.

In some other embodiments, the first area extends outwardly from the lens center to an outer periphery of the first area, the outer periphery of the first area having a radial distance to the lens center of a*L3, the second area extends outwardly from the outer periphery of the first area to an outer periphery of the second area, the outer periphery of the second area having a radial distance to the lens center of b*L3, and the third area extends outwardly from the outer periphery of the second area to an outer periphery of the third area, the outer periphery of the third area having a radial distance to the lens center of L3, wherein L3 is a radius length of the optical region, a is 0.3 to 0.56, b is 0.5 to 0.78, and a<b.

According to certain embodiments of the present invention, a spacing between the at least two defocusing zones and the at least one correction zone in the second area is greater than or equal to 0.2 mm, and is preferably 0.2 or 0.25 mm.

In certain embodiments of the present invention, a spacing between the at least two defocusing zones and the at least one correction zone in the third area is greater than or equal to 0.2 mm, and is preferably 0.2 or 0.25 mm.

According to certain embodiments of the present invention, in the second and third areas, powers between the at least two defocusing zones and the at least one correction zone are altered continuously or progressively. In other words, the change from one target power to another target power is continuous.

According to some other embodiments, in the second and third areas, powers between the at least two defocusing zones and the at least one correction zone are altered discontinuously or step-wise. In other words, the change from one target power to another target power is directly and without intermediate powers.

In certain embodiments of the present invention, there are a plurality of different first power differences.

In certain embodiments of the present invention, there are a plurality of different second power differences.

According to certain embodiments of the present invention, the first area includes a plurality of correction zones. The plurality of correction zones may have an adjustment correcting power ranging from −2.5 to 2.5 D.

In addition, the present invention further provides a mold for manufacturing a contact lens as described above.

These and other aspects will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The foregoing summary, as well as the following detailed description of the invention, will be better understood when read in conjunction with the appended drawing. In the drawings:

FIG. 1 is a schematic diagram showing correction of myopia by a conventional contact lens.

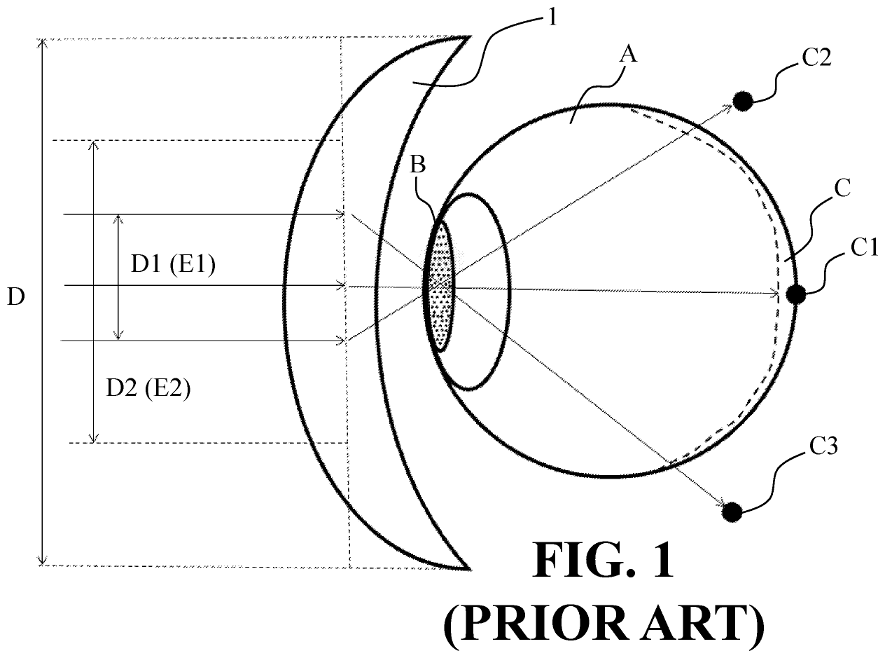

FIG. 2 is a schematic diagram showing correction of myopia by a contact lens of the present invention.

FIG. 3 shows the arrangements of at least three areas in an optical region according to one embodiment of the present invention.

FIG. 4 illustrates a lens power profile according to a first embodiment of the present invention.

FIG. 5 illustrates a lens power profile according to a second embodiment of the present invention.

FIG. 6 illustrates a lens power profile according to a third embodiment of the present invention.

FIG. 7 illustrates a lens power profile according to a fourth embodiment of the present invention.

FIG. 8 illustrates a lens power profile according to a fifth embodiment of the present invention.

FIG. 9 illustrates a lens power profile according to a sixth embodiment of the present invention.

FIG. 10 is a sectional view of a mold for manufacturing a contact lens according to one embodiment of the present invention.

### DESCRIPTION OF THE INVENTION

Unless defined otherwise, all technical and scientific terms used herein have the same meaning as commonly understood by a person skilled in the art to which this invention belongs.

As used herein, the singular forms “a”, “an”, and “the” include plural referents unless the context clearly dictates otherwise. Thus, for example, reference to “a sample” includes a plurality of such samples and equivalents thereof known to those skilled in the art.

The average diameter of pupil of human eyes is about 9 mm. When looking at near objects, average pupil diameter would decrease to within 4 mm, and when looking at distant objects, average pupil diameter would increase to 6 mm or more. Therefore, in the present invention, 4 mm, 6 mm and 9 mm diameters are used as the boundaries of the visual area of the contact lens. In terms of design, the effective visual region (optical region) of a contact lens is divided into three areas, which are a first area covering a radial distance of 0˜L1 (inclusive of L1) to a lens center O, a second area covering a radial distance of L1˜L2 (inclusive of L2) to the lens center O, and a third area covering a radial distance of L2˜L3 (inclusive of L3) to the lens center O, wherein L1 is 2±0.5 mm, L2 is 3±0.5 mm, and L3 is 4.5±0.5 mm.

Further, the first area is arranged with at least one correction zone having a nearsightedness correcting power, and each of the second and third areas is arranged with at least two defocusing zones and at least one correction zone, said defocusing zones being used for generating defocused images in front of the retina to slow the progression of myopia. The at least two defocusing zones and the at least one correction zone are alternatively arranged on the contact lens. Preferably, the at least two defocusing zones and the at least one correction zone are alternatively and concentrically arranged. The second area has a first power difference of −2.00 to −5.00 D, the third area has a second power difference of −3.00 to −10.00 D, and the second power difference is equal to or more negative than the first power difference. Accordingly, a contact lens of the present invention has an effect of slowing the progression of myopia.

The term “first power difference” as used herein generally refers to a power difference in the second area between a correction zone and a defocusing zone. The term “second power difference” as used herein generally refers to a power difference in the third area between a correction zone and a defocusing zone.

Alternatively, the effective visual region (optical region) of a contact lens is divided, in proportion to L3 (a radius length of the optical region E2), into three areas: a first area covering a radial distance of 0˜a*L3 (inclusive of a*L3) to a lens center O, a second area covering a radial distance of a*L3˜b*L3 (inclusive of b*L3) to the lens center O, and a third area from covering a radial distance of b*L3˜L3 (inclusive of L3) to the lens center O, wherein a is 0.3 to 0.56, b is 0.5 to 0.78, and a<b. For example, if L3 is 4.5±0.5 mm, a*L3 may be 2±0.5 mm and b*L3 may be 3±0.5 mm.

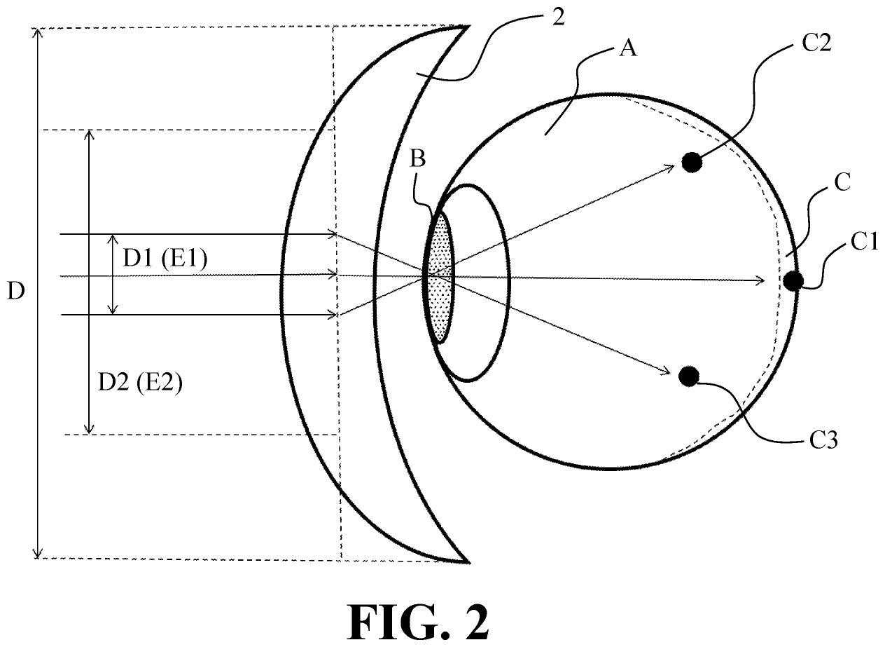

Please refer to FIG. 2, a schematic diagram showing correction of myopia by a contact lens of the present invention. As shown in FIG. 2, on the basis of satisfying the correction for myopia, a contact lens 2 makes a central focus C1 still fall on the retinal imaging area C, but an upper peripheral focus C2 and a lower peripheral focus C3 fall in front of the retina through lens design. Although such design would result in an insufficient correction and the brain would send a signal to alter the axial length of eyes, the axial length would not increase and the myopia would not worsen, thereby achieving the purpose of slowing the progression of myopia.

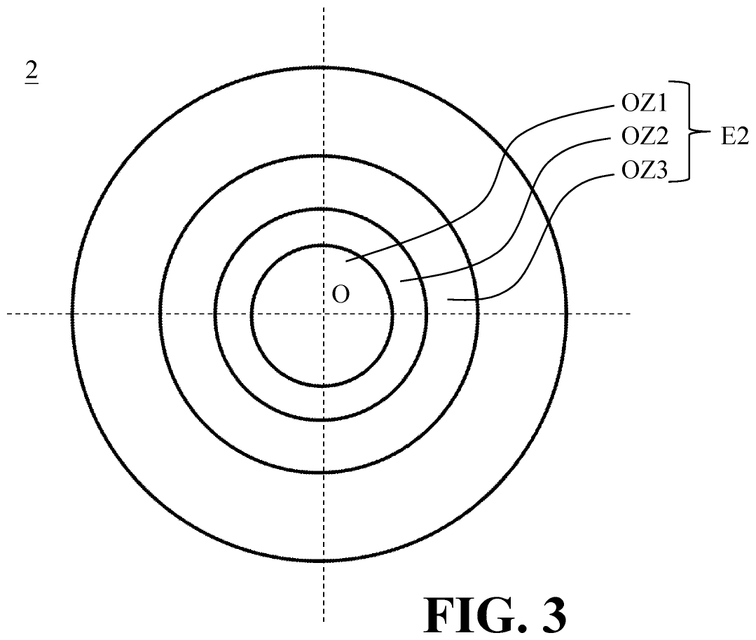

Please refer to FIG. 3 showing the arrangements of at least three areas in an optical region according to one embodiment of the present invention. An optical region (effective visual region) E2 of a contact lens 2 is divided into three areas, a first area OZ1, a second area OZ2 and a third area OZ3. The first area OZ1 covers a radial distance of 0˜L1 (inclusive of L1) to a lens center O, the second area OZ2 covers a radial distance of L1˜L2 (inclusive of L2) to the lens center O, and the third area OZ3 covers a radial distance of L2˜L3 (inclusive of L3) to the lens center O, wherein L1 is 2±0.5 mm, L2 is 3±0.5 mm, and L3 is 4.5±0.5 mm.

The first area OZ1 may include one correction zone having a (nearsightedness) correcting power, or may include a plurality of correction zones (with different correction powers). Each of the second area OZ2 and the third area OZ3 includes a correction zone having a (nearsightedness) correcting power and a defocusing zone, and the correction zone and the defocusing zone are alternately arranged. In certain embodiments of the present invention, the second area OZ2 has a first power difference (between correction and defocusing zones) of −2.00 to −5.00 D. It is notable that a power difference less negative than −2.00 D may result in a lack of defocusing effects. On the other hand, the third area OZ3 has a second power difference (between correction and defocusing zones) of −3.00 to −10.00 D. In addition, the second power difference is equal to or more negative than the first power difference.

Through the above design, the first area OZ1 has a sufficient correcting power to correct myopia, the second area OZ2 has a defocusing effect such that the focus does not fall behind the retina, and at the same time the second area OZ2 has a moderate first power difference to avoid an image jump. Further, the third area OZ3 has a second power difference equal to or more negative than the first power difference, so as to provide a further defocusing effect to better direct the peripheral focuses of the contact lens 2 in front of the retina.

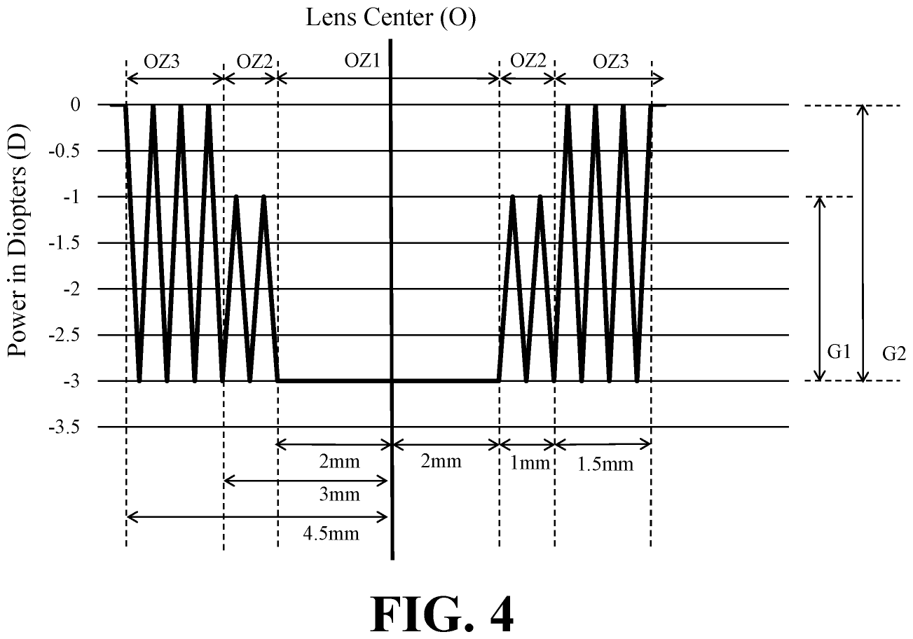

Now please refer to FIG. 4 illustrating a lens power profile according to a first embodiment of the present invention. In this embodiment, a first area OZ1 covers a radial distance of 0˜2 mm (inclusive of 2 mm) to a lens center O, and a second area OZ2 covers a radial distance of 2˜3 mm (inclusive of 3 mm) to the lens center O, and a third area OZ3 covers a radial distance of 3˜4.5 mm (inclusive of 4.5 mm) to the lens center O. The first area OZ1 has a nearsightedness correcting power of −3.00 D (say P1), and the second area OZ2 includes a defocusing zone having a first defocusing power of −1.00 D (any P2), and the third area OZ3 includes a defocusing zone having a second defocusing power of 0 D (say P3). Accordingly, the second area OZ2 has a first power difference (also called “first defocusing extent”) G1 of −2.00 D (P1−P2=−3.00 D−(−1.00 D)=−2.00 D), and the third area OZ3 has a second power difference (also called “second defocusing extent”) G2 of −3.00 D (P1−P3=−3.00 D−0 D=−3.00 D).

Further, in the second area OZ2, the spacing between correction zone(s) and defocusing zone(s) is 0.25 mm; and in the third area OZ3, the spacing between correction zone(s) and defocusing zone(s) is 0.25 mm. In addition, the power alteration between correction zone(s) and defocusing zone(s) is continuous (or progressive).

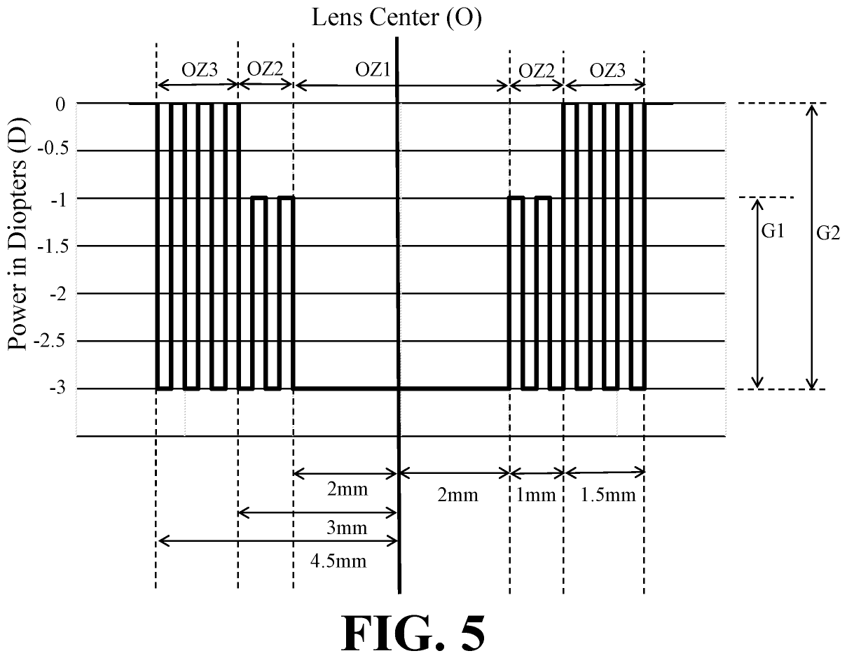

Please refer to FIG. 5 illustrating a lens power profile according to a second embodiment of the present invention. The lens power profile of this second embodiment is generally the same as that of the first embodiment, with the difference that, in the present embodiment, the power alteration between correction zone(s) and defocusing zone(s) is discontinuous (or step-wise). That is, the change from one target power to another target power is directly and without intermediate powers.

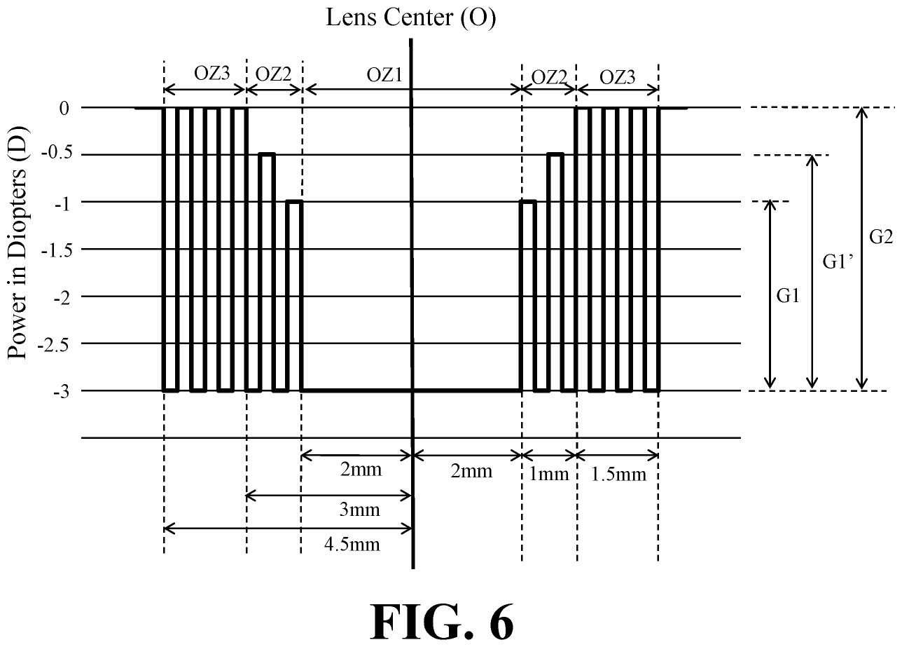

Please turn to FIG. 6 illustrating a lens power profile according to a third embodiment of the present invention. The lens profile of this third embodiment is generally the same as that of the second embodiment, and the difference lies in that there are two different first power differences G1 of −2.00 D and G1′ of −2.50 D, respectively.

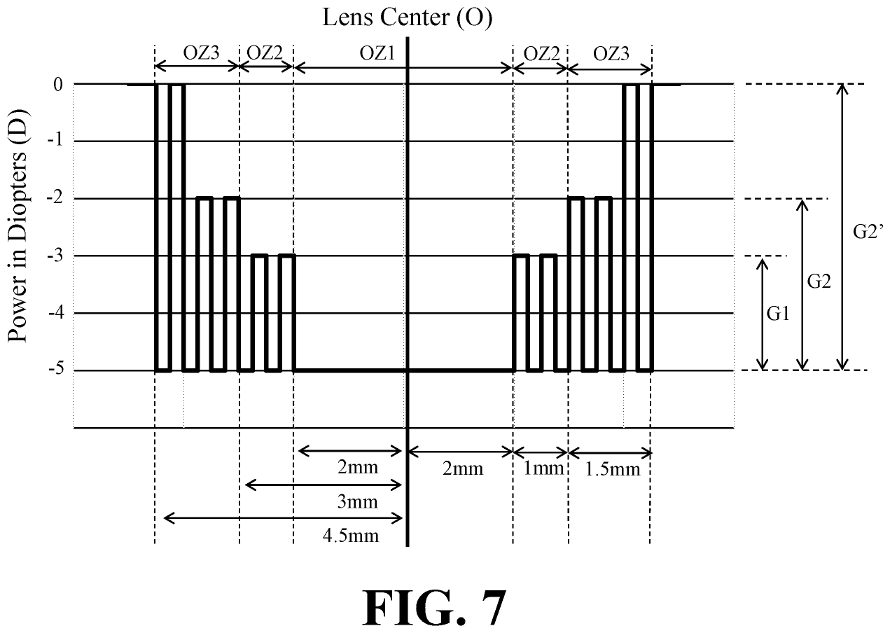

Please refer to FIG. 7 illustrating a lens power profile according to a fourth embodiment of the present invention. The lens power profile of this fourth embodiment is generally the same as that of the second embodiment, with the difference that, a first area OZ1 has a nearsightedness correcting power of −5.00 D, and there are two different second power differences G2 of −3.00 D and G2′ of −5.00 D, respectively.

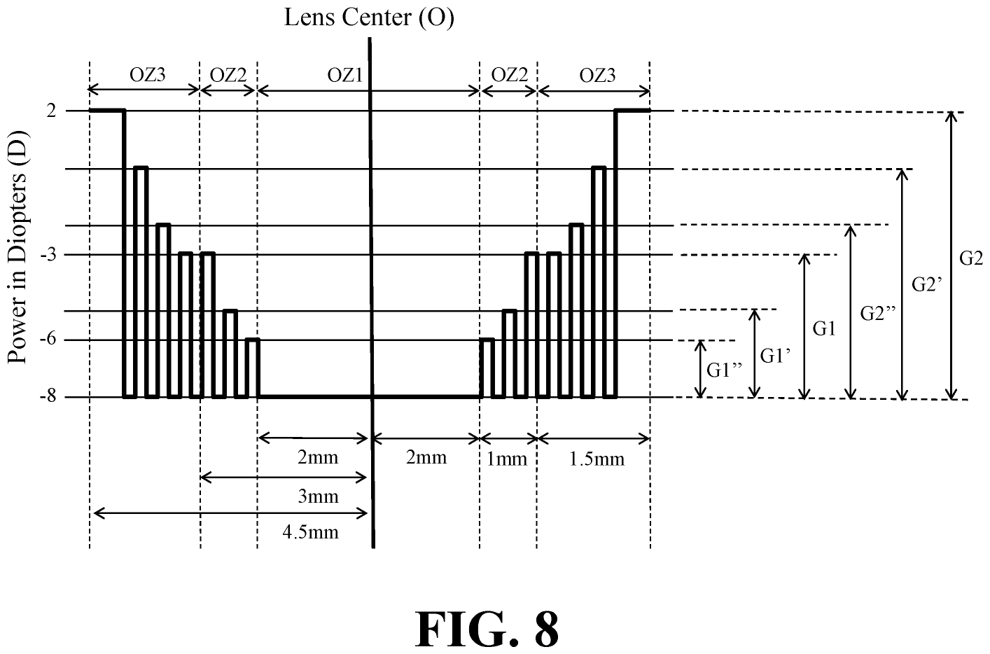

Now please refer to FIG. 8 illustrating a lens power profile according to a fifth embodiment of the present invention. The lens power profile of this fifth embodiment is generally the same as that of the second embodiment, with the following difference: (i) a first area OZ1 has a nearsightedness correcting power of −8.00 D; (ii) there are three different first power differences G1 of −5.00 D, G1′ of −3.00 D and G1” of −2.00 D, respectively; and (iii) there are four different second power differences G2 of −10.00 D, G2′ of −8.00 D, G2″ of −6.00 D and G2′″ of −5.00 D, respectively. Further, in the present embodiment, the power alteration between correction zone(s) and defocusing zone(s) is discontinuous (or step-wise). In addition, the spacing between correction zone(s) and defocusing zone(s) in both second and third areas OZ2, OZ3 is 0.2 mm.

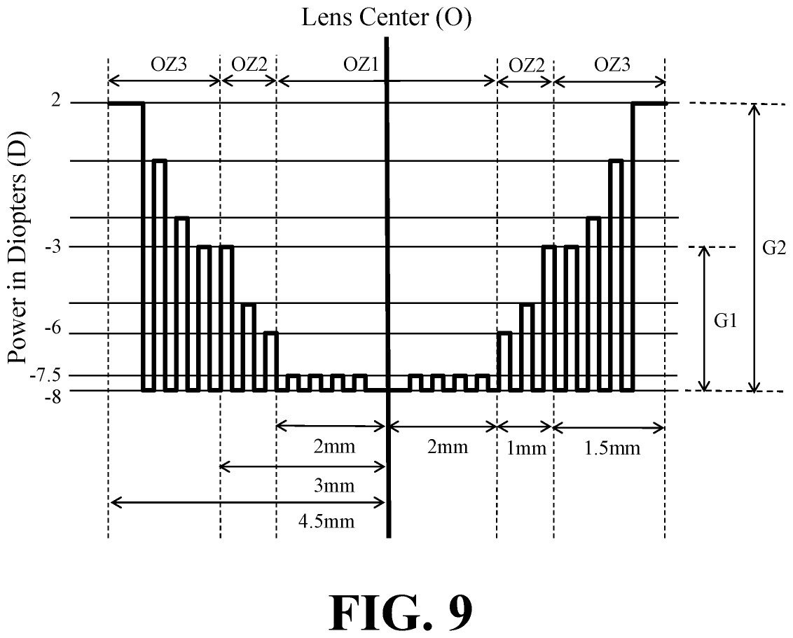

Please refer to FIG. 9 illustrating a lens power profile according to a sixth embodiment of the present invention. In this sixth embodiment, a first area OZ1 is arranged with a plurality of correction zones. Such alterative design of first area OZ1 can enhance the contact lens' performance in near object vision, wherein the first area OZ1 may have an adjustment correcting power ranging from −2.5 to 2.5 D for near object vision. According to the present embodiment, the first area OZ1 has a nearsightedness correcting power of −8.00 D, and an adjustment correcting power +0.50 D for near object vision. There are three different first power differences G1 of −5.00 D, G1′ of −3.00 D and G1″ of −2.00 D, respectively. On the other hand, there are four different second power differences G2 of −10.00 D, G2′ of −8.00 D, G2″ of −6.00 D and G2′″ of −5.00 D, respectively. The power alteration between correction zone(s) and defocusing zone(s) is discontinuous (or step-wise). In addition, the spacing between correction zone(s) and defocusing zone(s) in both second and third areas OZ2, OZ3 is 0.2 mm.

It is notable that in the second area OZ2 or the third area OZ3, the spacing between correction zone(s) and defocusing zone(s) may be as small as 0.2 mm, but is not limited thereto. Preferably, the spacing is at least 0.2 mm. For example, the spacing may be about 0.2, 0.21, 0.22, 0.23, 0.24, 0.25, 0.26, 0.27, 0.28, 0.29, or 0.3 mm. More preferably, the spacing is 0.2-0.25 mm. Even more preferably, the spacing is 0.2 or 0.25 mm.

As used herein, the term “spacing” between correction zone(s) and defocusing zone(s) refers to a distance between a midpoint or midline of a correction zone and a midpoint or midline of a defocusing zone. In the case that the power alteration between correction zone(s) and defocusing zone(s) is continuous, a correction zone or a defocusing zone generally reaches its target power at the midline.

In addition, corneal topography was used to verify the effects achieved by a contact lens of the present invention. The corneal topography measures feedback information from the cornea when a user wears a contact lens. Through the feedback information obtained by the corneal topography, the effect and burden brought by the design of the contact lens to the cornea can be indirectly and quickly understood. Traditional lenses for myopia correction do not put further pressure on the cornea, allowing the cornea to change in its natural way, and as explained above, such traditional lenses would cause increase of the axial length and therefore myopia worsening in schoolchildren. Orthokeratology lenses, through the adjustment of lens design, apply moderate compression around the cornea, so that edema is formed around the cornea, and in turn causes change of degree of myopia. According to the information disclosed by ophthalmic medical institutes, orthokeratology lenses clinically can not only temporarily correct nearsightedness to restore normal vision, but also effectively control the progression of myopia. Mitigating progression of myopia is the most valuable factor of the use of orthokeratology lenses in school-aged children and adolescents. Six academic institutions, including the UC Berkeley School of Optometry, the University of Houston College of Optometry, the UC San Diego School of Medicine, and the Pacific University College of Optometry, have published research reports on orthokeratology lenses, and the clinical results show that there are almost no adverse side effects during the treatment by orthokeratology lenses, which proves that orthokeratology lenses are a safe and effective corrective measure. Also, orthokeratology lenses have been approved by the United States Food and Drug Administration (USFDA). Corneal topography results show that a contact lens of the present invention makes the cornea to exhibit optical properties similar to that caused by orthokeratology lenses, thereby effecting the mitigation of the progression of myopia.

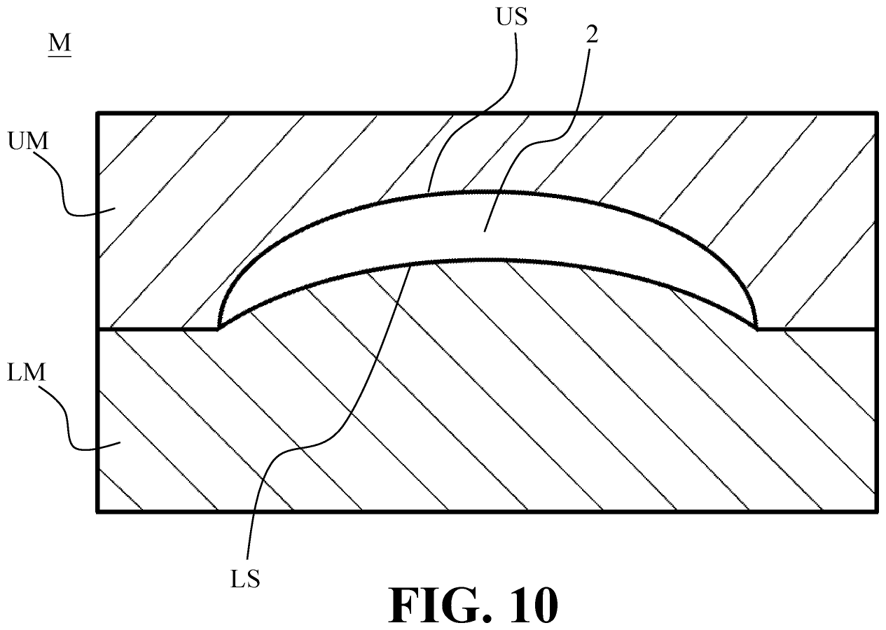

Referring to FIG. 10, which is a sectional view of a mold for manufacturing a contact lens, a contact lens of the present invention may be prepared by pressing materials for contact lenses using an upper mold part UM and a lower mold part LM of a mold M. A plurality of microstructures are formed on a pressing surface US of the upper mold part UM and a pressing surface LS of the lower mold part, such that a contact lens 2 obtained has a desired lens profile, for example, that of anyone of the first to sixth embodiments as described above.

In summary, corneal topography results show that a contact lens of the present invention makes the cornea to exhibit optical properties similar to that caused by orthokeratology lenses, thereby fulfilling the effect of mitigating the progression of myopia. Further, moderate first power difference in the second area avoids an image jump, and therefore improves comfortability of wearers.

It is believed that a person of ordinary knowledge in the art where the present invention belongs can utilize the present invention to its broadest scope based on the descriptions herein with no need of further illustration. Therefore, the descriptions and claims as provided should be understood as of demonstrative purpose instead of limitative in any way to the scope of the present invention.

1. A contact lens, comprising:
an optical region including a first area, a second area and a third area, concentrically arranged in such order from a lens center;
wherein the first area includes a correction zone having a nearsightedness correcting power;
wherein the second and third areas each include at least two defocusing zones and at least one correction zone, and the at least two defocusing zones and the at least one correction zone are alternatively arranged; and
wherein the second area has a first power difference of −2.00 to −5.00 D, the third area has a second power difference of −3.00 to −10.00 D, and the second power difference is equal to or more negative than the first power difference.

2. The contact lens according to claim 1, wherein the first area extends outwardly from the lens center to an outer periphery of the first area, the outer periphery of the first area having a radial distance to the lens center of L1, the second area extends outwardly from the outer periphery of the first area to an outer periphery of the second area, the outer periphery of the second area having a radial distance to the lens center of L2, and the third area extends outwardly from the outer periphery of the second area to an outer periphery of the third area, the outer periphery of the third area having a radial distance to the lens center of L3; and wherein L1 is 2±0.5 mm, L2 is 3±0.5 mm, and L3 is 4.5±0.5 mm.

3. The contact lens according to claim 1, wherein the first area extends outwardly from the lens center to an outer periphery of the first area, the outer periphery of the first area having a radial distance to the lens center of a*L3, the second area extends outwardly from the outer periphery of the first area to an outer periphery of the second area, the outer periphery of the second area having a radial distance to the lens center of b*L3, and the third area extends outwardly from the outer periphery of the second area to an outer periphery of the third area, the outer periphery of the third area having a radial distance to the lens center of L3; and wherein L3 is a radius length of the optical region, a is 0.3 to 0.56, b is 0.5 to 0.78, and a<b.

4. The contact lens according to claim 1, wherein a spacing between the at least two defocusing zones and the at least one correction zone is greater than or equal to 0.2 mm.

5. The contact lens according to claim 1, wherein a spacing between the at least two defocusing zones and the at least one correction zone is preferably 0.2 mm or 0.25 mm.

6. The contact lens according to claim 1, wherein powers between the at least two defocusing zones and the at least one correction zone are altered continuously or discontinuously.

7. The contact lens according to claim 1, wherein the first area includes a plurality of correction zones.

8. The contact lens according to claim 7, wherein the plurality of correction zones have an adjustment correcting power ranging from −2.5 to 2.5 D.
